(19) United States
(12) Patent Application Publication
(10) Pub. No.: US 2013/0002882 A1
(43) Pub. Date: Jan. 3, 2013

(54) IMAGE-CAPTURING DEVICE

(75) Inventors: Kazutoshi ONOZAWA, Osaka (JP); Yoshihisa Kato, Shiga (JP); Shinzou Kouyama, Osaka (JP)

(73) Assignee: Panasonic Corporation, Osaka (JP)

(21) Appl. No.: 13/611,586

(22) Filed: Sep. 12, 2012

Related U.S. Application Data
(63) Continuation of application No. PCT/JP2010/005912, filed on Oct. 1, 2010.

(30) Foreign Application Priority Data
Apr. 23, 2010 (JP) 2010-100291

(51) Int. Cl. H04N 5/335; H04N 5/33

(52) U.S. Cl. 348/164; 348/E05.09; 348/E05.091

(57) ABSTRACT

The image-capturing device according to the present invention includes a solid-state imaging element, an infrared LED which emits infrared light, a light-emission controlling unit which causes the infrared LED to emit infrared pulsed light on a per frame time basis, and a signal processing unit which extracts, from the solid-state imaging element, a color visible-light image signal in synchronization with a non-emitting period and an infrared image signal in synchronization with an emitting period of the infrared LED. The solid-state imaging element includes an image-capturing region in which unit-arrays are two-dimensionally arranged, and each of the unit-arrays has a pixel for receiving green visible light and infrared light, a pixel for receiving red visible light and infrared light, a pixel for receiving blue visible light and infrared light, and a pixel for receiving infrared light.

### CROSS REFERENCE TO RELATED APPLICATIONS

This is a continuation application of PCT Patent Application No. PCT/JP2010/005912 filed on Oct. 1, 2010, designating the United States of America, which is based on and claims priority of Japanese Patent Application No. 2010-100291 filed on Apr. 23, 2010. The entire disclosures of the above-identified applications, including the specifications, drawings and claims are incorporated herein by reference in their entirety.

### TECHNICAL FIELD

The present invention relates to an image-capturing device which is capable of simultaneously outputting a color visible-light image and a monochrome infrared image.

### BACKGROUND ART

Conventionally, a camera used in both nighttime and daytime such as a monitoring camera and a network camera uses solid-state imaging elements such as Charge Coupled Device (CCD) and Metal Oxide Semiconductor (MOS) sensors. Such solid-state imaging elements have sensitivity in a wavelength range of approximately 400 nm to 1,000 nm, and direct incident light on the solid-state imaging elements from a subject causes an image to take on reddish color due to sensitivity for wavelength components in the infrared region (approximately 700 nm to 1,000 nm). Therefore, the above camera removes light in the infrared wavelengths using an infrared light cutting filter inserted between the lens and the solid-state imaging elements. Accordingly, the infrared light is cut, so that the above camera can have the same color reproducibility as that of vision of human eyes.

However, by removing the light in the infrared wavelengths as described above, a color image having good color reproducibility can be obtained when it is light, for example in daytime, but an image as good as that in daytime cannot be obtained when it is dark with less visible light, for example in nighttime.

Patent Literature (PTL) 1 and 2 disclose that an image is obtained by providing light including an infrared wavelength range to a light-receiving unit in a solid-state imaging element without using an infrared light cutting filter in nighttime in order to provide as much light as possible for the light-receiving unit in the solid-state imaging element.

Moreover, for security applications, an infrared lighting system has started to be used which emits light in an infrared region around 850 nm that is not perceived by human eyes at all. Such an infrared lighting system uses an infrared LED which emits infrared light, and others. With this, in the case of a crime, the criminal cannot notice at all that he/she is image-captured, but video having clear contrast can be obtained from the camera. Thus, the camera having the infrared lighting system has a significant advantage of being capable of monitoring with night vision.

### CITATION LIST

### Patent Literature

[PTL 1] Japanese Unexamined Patent Application Publication No. 11-239356

[PTL 2] Japanese Unexamined Patent Application Publication No. 2002-135788

### SUMMARY

### Technical Problem

However, the above-described conventional technique requires a mechanical system for inserting and removing the infrared light cutting filter. In such a mechanical system, the infrared light cutting filter cannot be instantaneously inserted or removed, resulting in a time-lag in switching video. Moreover, there is a problem in reliability, for example, repetitions of switching can cause a mechanical breakdown.

Furthermore, since the infrared lighting system using LEDs and others image-captures a subject that is irradiated with infrared light, the captured image is not a color image. Thus, use of such an infrared lighting system has a problem of failing to identify the color of the subject, for example, the color of the clothes of the criminal only from the image.

The present invention was conceived in view of the above-described problems and has as an object to provide an image-capturing device which is capable of providing a high-quality color image even with low ambient light, for example in nighttime, and simultaneously providing video having as clear contrast as that in the case of using the infrared lighting system.

### Solution to Problem

In order to solve the above-described problem, the image-capturing device according to an aspect of the present invention including: an image-capturing region in which unit-arrays are two-dimensionally arranged, each of the unit-arrays including a first unit-pixel having a filter that allows green visible light and infrared light to pass, a second unit-pixel having a filter that allows red visible light and infrared light to pass, a third unit-pixel having a filter that allows blue visible light and infrared light to pass, and a fourth unit-pixel having a filter that allows infrared light to pass; a light-emitting element which emits infrared light; a light-emission controlling unit which causes the light-emitting element to emit pulses of the infrared light by turning the light-emitting element ON or OFF on a per frame time basis; and a signal extracting unit which extracts, from the solid-state imaging element, a color visible-light image signal in synchronization with a non light-emitting period of the light-emitting element and an infrared image signal in synchronization with a light-emitting period of the light-emitting element, the light-emitting element being turned OFF or ON by the light-emission controlling unit.

This enables the image-capturing device to image-capture both a color visible-light image and an infrared image by electrically switching between the images on a per frame basis in high speed. By selecting the color visible-light image and the infrared image, and by viewing the both, it is possible to perceive, with clear contrast, even a part hidden by shadow in the color visible-light image, and further to identify, in the color visible-light image, the color of the subject such as the color of the clothes which cannot be perceived only from the infrared image.

Furthermore, for example, the signal extracting unit: includes an infrared difference unit which subtracts a signal from the fourth unit-pixel from a signal from each of the first unit-pixel, the second unit-pixel, the third unit-pixel to generate color signals; and extracts the color visible-light image signal or the infrared image signal from the color signals generated by the infrared difference unit and a luminance signal generated from any one of the first to the fourth unit-pixels.

That is, color signals can be generated by subtracting an infrared signal from each of an (red+infrared) signal, a (green+infrared) signal, and a (blue+infrared) signal in the infrared difference unit. Accordingly, the color image signal can be easily obtained by combining the color signals with the luminance signal. Moreover, in a state where irradiation with infrared LED light is add, all pixels have sensitivity for the infrared light and thus the sufficient amount of luminance signal can be secured, thereby enabling generation of the infrared image signal having clear contrast.

Furthermore, for example, in each of the unit-arrays: the first unit-pixel and the fourth unit pixel are adjacent to each other in a row direction or a column direction; and the first unit-pixel and the second unit-pixel are diagonally positioned.

With this, R and G pixels having high coefficients of a luminance signal Y (expressed by Y=0.3R+0.6G+0.1B) that is related to brightness and contrast of an image are diagonally positioned, so that the center of the luminance signal Y comes to near the center of the unit-array, thereby avoiding deterioration in a sense of resolution.

Furthermore, the light-emission controlling unit may cause the light-emitting element to emit, in pseudorandom pulses, the infrared light that is turned ON or OFF on a per frame time basis.

Accordingly, the image signal is extracted according a modulation of the pseudorandom pulses, so that possible incident light from other light sources on the solid-state imaging element can be separated, thereby reducing an influence of ambient light.

Furthermore, the pseudorandom pulses may be pulses of emitted light temporally modulated by the light-emission controlling unit in a pseudorandom manner using a spread spectrum system.

With this, the infrared light is diffused in a broadband, so that ambient light in a narrowband can be easily separated. Moreover, use of the light modulated by the spread spectrum system enables the relative position of a moving object to be measured by the difference in the arrival time of the light.

Furthermore, the signal extracting unit may separately extract the color visible-light image signal and the infrared image signal by despreading image signals captured by the solid-state imaging element.

With this, since the signal extracting unit despreads the signal from the solid-state imaging element, resistance to disturbance wave and interference wave can be obtained, and S/N ratio can be increased.

Furthermore, the image-capturing device may further include: a detecting unit which detects whether or not intensity of the signal from the fourth unit-pixel is greater than or equal to predetermined intensity; and a light reducing unit which reduces the infrared light when the detection unit determines the intensity of the signal is greater than or equal to the predetermined intensity.

With this, in the case where the captured signals in the solid-state imaging element are saturated, it is possible to reduce incident light on the solid-state imaging element 10.

Furthermore, the image-capturing device may further include an accumulating unit which accumulates at least one of the color visible-light image signal and the infrared image signal.

With this, while viewing either the color visible-light image or the infrared image on an image outputting unit, the image that is not viewed or the both images can be saved in the signal accumulating unit, and the saved images can be viewed afterward according to a necessity.

Furthermore, for example, the solid-state imaging element includes a signal outputting unit which outputs the color visible-light image signal or the infrared image signal at 1/60 second or less.

This enables, for example, the image-capturing device to image-capture the color visible-light image and the infrared image that is given clear contrast by infrared light one after the other on a per frame basis per 30 fps for each.

### Advantageous Effects

According to the image-capturing device in the present invention, a color visible-light image and a monochrome infrared image can be simultaneously outputted.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a function block diagram showing an image-capturing device according to Embodiment 1 of the present invention.

FIG. 2 is a timing chart showing image-capturing timing of a solid-state imaging element according to Embodiment 1 of the present invention.

FIG. 3 is a timing chart showing emission timing of an infrared LED according to Embodiment 1 of the present invention.

FIG. 4 is a diagram showing temporal transition of images captured in dim light by the image-capturing device according to Embodiment 1 of the present invention.

FIG. 5A is a color image in the case of driving, at 1/60 second per frame, the solid-state imaging element according to Embodiment 1 of the present invention.

FIG. 5B is a monochrome infrared image in the case of driving, at 1/60 second per frame, the solid-state imaging element according to Embodiment 1 of the present invention.

FIG. 6 is a diagram showing a schematic structure and a pixel arrangement of the solid-state imaging element according to Embodiment 1 of the present invention.

FIG. 7A is a graph showing spectral sensitivity of a unit-pixel having sensitivity in wavelengths of blue light and infrared light.

FIG. 7B is a graph showing spectral sensitivity of a unit-pixel having sensitivity in wavelengths of green light and infrared light.

FIG. 7C is a graph showing spectral sensitivity of a unit-pixel having sensitivity in wavelengths of red light and infrared light.

FIG. 7D is a graph showing spectral sensitivity of a unit-pixel having sensitivity in wavelength of infrared light.

FIG. 8 is a function block diagram showing a signal processing unit in the image-capturing device according to Embodiment 1 of the present invention.

FIG. 9A is a graph showing spectral sensitivity characteristics obtained by subtracting the spectral sensitivity characteristics in FIG. 7D from the spectral sensitivity characteristics in FIG. 7A.

FIG. 9B is a graph showing spectral sensitivity characteristics obtained by subtracting the spectral sensitivity characteristics in FIG. 7D from the spectral sensitivity characteristics in FIG. 7B.

FIG. 9C is a graph showing spectral sensitivity characteristics obtained by subtracting the spectral sensitivity characteristics in FIG. 7D from the spectral sensitivity characteristics in FIG. 7C.

FIG. 10A is an image captured in the state being irradiated with light from a halogen lamp by the image-capturing device according to Embodiment 1 of the present invention.

FIG. 10B is an image captured in the state being irradiated with infrared LED light in addition to the light from the halogen lamp by the image-capturing device according to Embodiment 1 of the present invention.

FIG. 11 is a timing chart showing emission timing of an infrared LED according to Embodiment 2 of the present invention.

FIG. 12 is a diagram showing temporal transition of images captured in dim light by an image-capturing device according to Embodiment 2 of the present invention.

FIG. 13 is a diagram showing an example of a circuit configuration of a Maximal-length Sequence (an M-sequence) signal generator in a light-emission controlling unit 60 according to Embodiment 2 of the present invention.

FIG. 14 is a timing chart showing emission timing of the infrared LED generated by the M-sequence signal generator.

FIG. 15 is a timing chart showing emission timing of the infrared LED according to a variation of Embodiment 2 of the present invention.

### DESCRIPTION OF EMBODIMENTS

The following is a detailed description of embodiments of the present invention with reference to the drawings.

### Embodiment 1

The following describes the structure of an image-capturing device (camera system) 100 according to Embodiment 1 of the present invention.

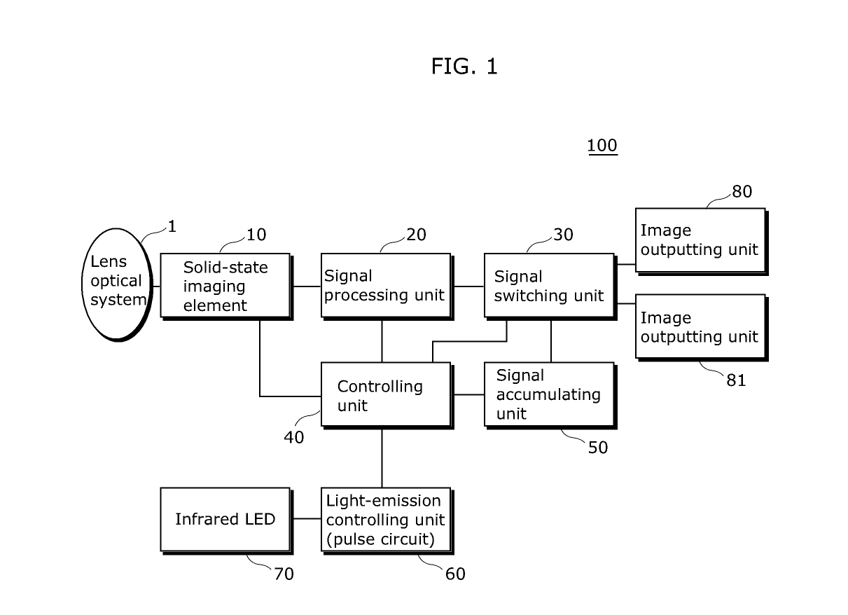

FIG. 1 is a function block diagram showing an image-capturing device according to Embodiment 1 of the present invention. The image-capturing device 100 illustrated in the drawing includes a lens optical system 1, a solid-state imaging element 10, a signal processing unit 20, a signal switching unit 30, a controlling unit 40, a signal accumulating unit 50, a light-emission controlling unit 60, an infrared LED 70 which is a light-emitting element emitting infrared light, and image outputting units 80 and 81. It should be noted that although a CMOS imaging sensor, for example, is used as the solid-state imaging element 10, it is not limited to the CMOS imaging sensor, and a CCD imaging sensor, for example, may also be used. It should also be noted that all or a part of the structure except the solid-state imaging element 10 and the lens optical system 1 can also be formed on a same semiconductor substrate.

In the image-capturing device 100, an optical signal from a subject provided through the lens optical system 1 is converted to an electrical signal on a per pixel basis by the solid-state imaging element 10, and the electrical signal is converted to a video signal in the signal processing unit 20. Subsequently, the video signal is displayed, as video, on the image outputting units 80 and 81 or an external image outputting device via the signal switching unit. Examples of exterior light for illuminating the subject include sunlight, moonlight, street lights, light from buildings, and light from display advertisements. Moreover, examples of interior light include fluorescent lamps and incandescent lamps, and the latest examples include LED lamps.

The fluorescent lamps, the LED lamps, and others emit light in the wavelength range of visible light, and the sunlight and the incandescent lamps emit light in both the wavelength range of visible light and the wavelength range of infrared light.

Furthermore, the image-capturing device 100 includes the infrared LED 70 and the light-emission controlling unit 60, and is capable of causing the infrared LED 70 to emit modulated infrared pulsed light on a per frame time basis. With this, the image-capturing device 100 image-captures the subject illuminated with the infrared light from the infrared LED 70 in nighttime or in dim light, so as to provide a clearly-contrasted image of the subject to the image outputting units 80 and 81 or the external image outputting device.

The controlling unit 40 determines emission timing of pulsed light from the infrared LED 70 and instructs the light-emission controlling unit 60 about the timing. More specifically, the controlling unit 40 determines the timing to drive the infrared LED 70 to emit pulsed light based on timing of a horizontal blanking period and timing of an image-capturing period of one frame of the solid-state imaging element 10. The light-emission controlling unit 60 is a pulse circuit which generates, in response to an instruction from the controlling unit 40, a driving pulse signal for controlling the infrared LED 70 such that the pulsed light is turned ON or OFF. In other words, the light-emission controlling unit 60 has a function to cause the infrared LED 70 to emit infrared pulsed light on a per frame time basis.

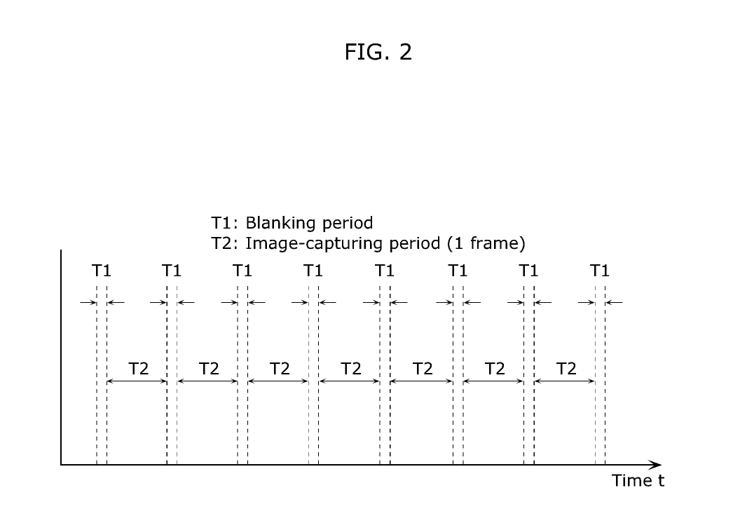

FIG. 2 is a timing chart showing image-capturing timing of the solid-state imaging element 10 according to Embodiment 1 of the present invention. In FIG. 2, a period T1 is a horizontal blanking period when a light signal is not received, and a period T2 is an image-capturing period (one frame) when a light signal is received. In the timing chart shown in FIG. 2, the length of each blanking period T1 is the same, and the length of each image-capturing period T2 is also the same.

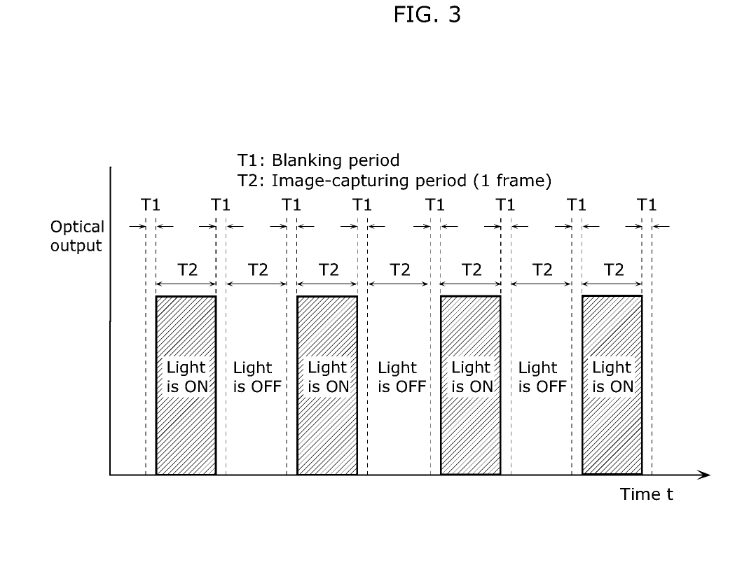

FIG. 3 is a timing chart showing emission timing of the infrared LED 70 according to Embodiment 1 of the present invention. As shown in the chart, the infrared LED 70 is repeatedly turned ON or OFF. When turned ON, the infrared LED 70 starts emitting pulsed light during a horizontal blanking period, and when turned OFF, the infrared LED 70 stops emitting the pulsed light during a horizontal blanking period. Moreover, in the timing chart showing the emission timing, the infrared LED 70 is repeatedly turned ON or OFF on a per frame basis. With this, the image-capturing device 100 is capable of alternately image-capturing a color image and a monochrome infrared image on a per frame basis.

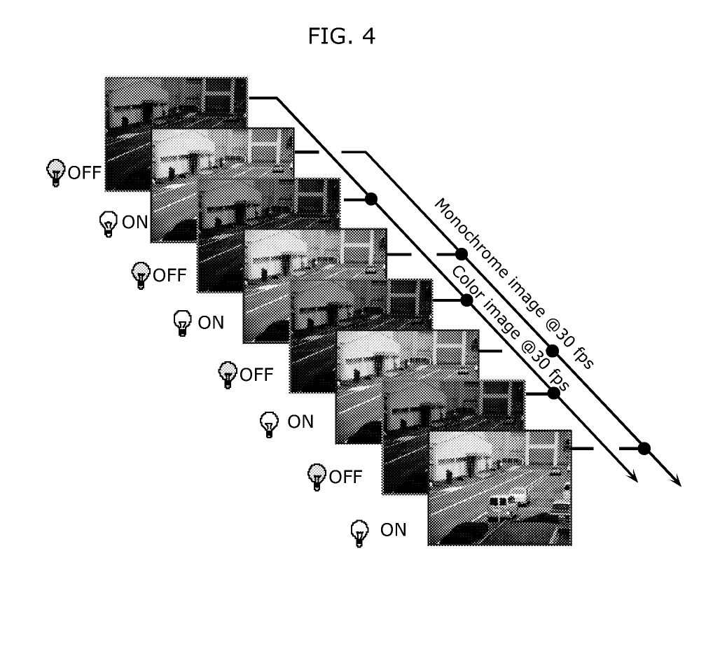

FIG. 4 is a diagram showing temporal transition of images captured in dim light by the image-capturing device according to Embodiment 1 of the present invention. The controlling unit 40 turns the infrared LED 70 ON or OFF on a per frame basis, and causes the solid-state imaging element 10 to drive at 1/60 second per frame. The solid-state imaging element 10 includes a signal outputting unit which outputs a color image signal received and converted when the infrared LED 70 is OFF, or an infrared image signal received and converted when the infrared LED 70 is ON. At this time, the signal outputting unit outputs the image signal at 1/60 second or less.

In this case, in dim light, the image-capturing device 100 can image-capture a color image and a monochrome image that is given clear contrast by infrared light one after the other on a per frame basis at 30 fps for each.

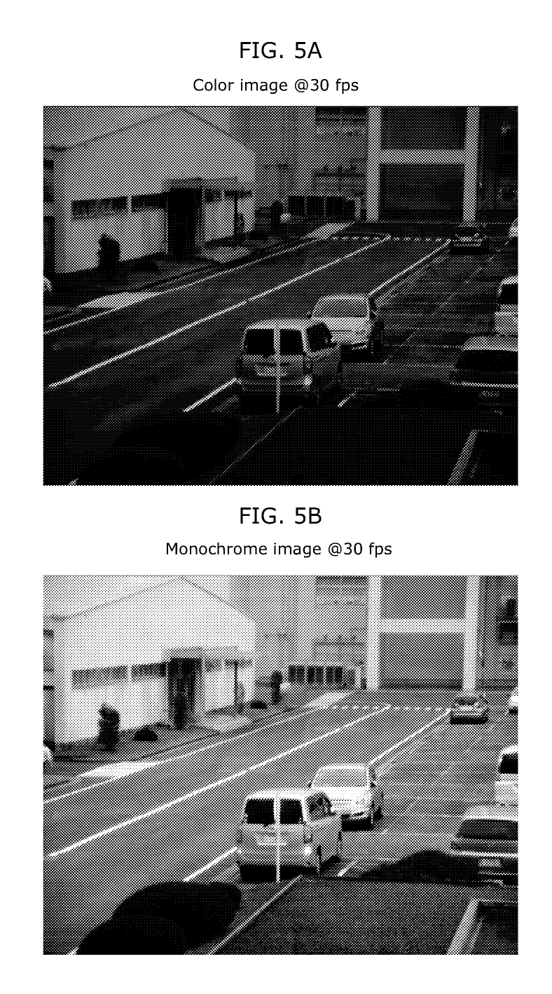

FIG. 5A is a color image in the case of driving, at 1/60 second per frame, the solid-state imaging element 10 according to Embodiment 1 of the present invention, and FIG. 5B is a monochrome infrared image in the case of driving, at 1/60 second per frame, the solid-state imaging element 10 according to Embodiment 1 of the present invention.

The controlling unit 40 causes the signal switching unit 30 to switch between a signal to the image outputting unit 80 and a signal to the image outputting unit 81 in synchronization with the pulse timing of the infrared LED 70. As a result, it is possible to separately view the color image in FIG. 5A in the image outputting unit 80 and the monochrome image that is given clear contrast by infrared light in FIG. 5B in the image outputting unit 81 at 30 fps for each. Moreover, it is possible, while viewing either the color image or the monochrome image, to save the image that is not viewed or the both images in the signal accumulating unit 50 which is an accumulating unit. The saved images can be viewed afterward according to a necessity. At this time, image-capturing time is recorded on the images, for example.

Furthermore, it is also possible to generate an image having improved recognition performance by combining the color image and the monochrome image.

Next, details of each unit included in the image-capturing device 100 are described.

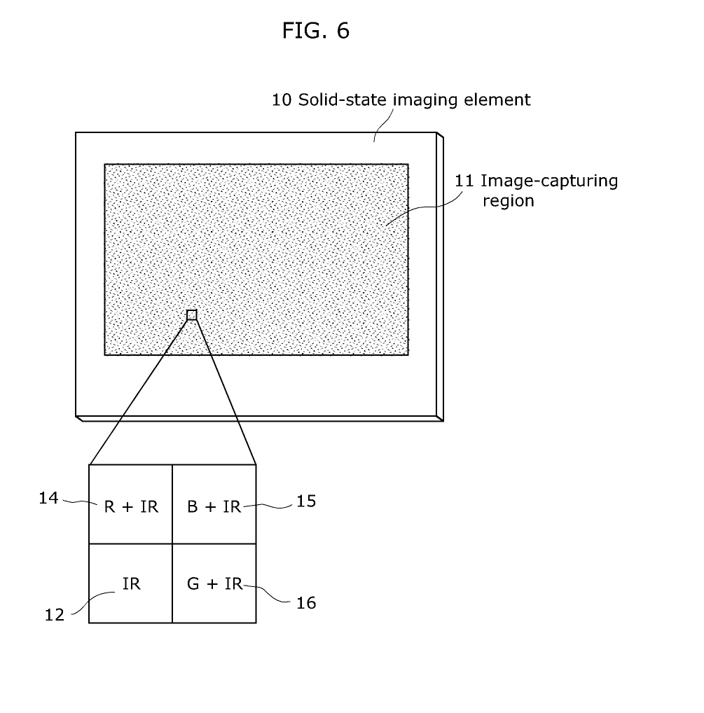

FIG. 6 is a diagram showing a schematic structure and a pixel arrangement of the solid-state imaging element 10 according to Embodiment 1 of the present invention. In the solid-state imaging element 10, unit-pixels (for example, the size of a pixel is 3.75 μm×3.75 μm) are two-dimensionally arranged in an image-capturing region 11. Each unit-pixel arranged in the image-capturing region 11 includes a unit-pixel 12 having a filter that allows infrared light to pass and having sensitivity only in the wavelengths of the infrared light, a unit-pixel 14 having a filter that allows red light and infrared light to pass and having sensitivity in the wavelengths of the red light and the infrared light, a unit-pixel 15 having a filter that allows blue light and infrared light to pass and having sensitivity in the wavelengths of the blue light and the infrared light, and a unit-pixel 16 having a filter that allows green light and infrared light to pass and having sensitivity in the wavelengths of the green light and the infrared light. Moreover, in the image-capturing region 11, four unit-pixels 12, 14, 15, and 16 are arranged in a square shape as a unit-array. The above arrangement of the unit-pixels 12, 14, 15, and 16 allows both a color visible-light image and an infrared image to be captured. The following describes reasons why the above-described arrangement of the unit-pixels enables both the color visible-light image and the infrared image to be captured.

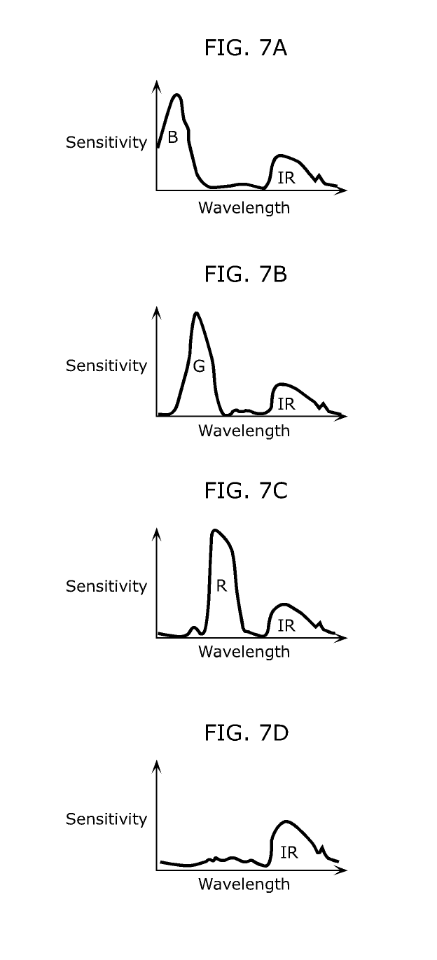

FIGS. 7A to 7D are graphs showing spectral sensitivity characteristics of each unit-pixel according to Embodiment 1 of the present invention. The graph in FIG. 7A shows the spectral sensitivity characteristics of the unit-pixel 15 that has sensitivity in the wavelengths of blue light and infrared light. The graph in FIG. 7B shows the spectral sensitivity characteristics of the unit-pixel 16 that has sensitivity in the wavelengths of green light and infrared light. The graph in FIG. 7C shows the spectral sensitivity characteristics of the unit-pixel 14 that has sensitivity in the wavelengths of red light and infrared light. The graph in FIG. 7D shows the spectral sensitivity characteristics of the unit-pixel 12 that has sensitivity only in the wavelength of infrared light.

Here, the signal processing unit 20 is described. The signal processing unit 20 is a signal extracting unit which extracts, from the solid-state imaging element 10, the infrared image signal in synchronization with a light-emitting period of the infrared LED 70 and the color visible-light image signal in synchronization with a non light-emitting period of the infrared LED 70 which is turned ON or OFF in response to a driving pulse signal from the light-emission controlling unit 60.

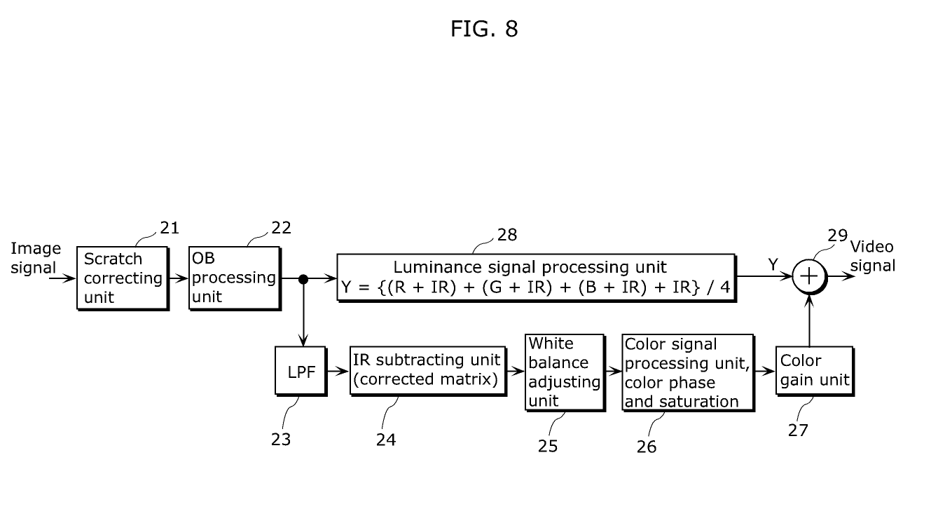

FIG. 8 is a function block diagram showing the signal processing unit included in the image-capturing device according to Embodiment 1 of the present invention. The signal processing unit 20 illustrated in the diagram includes a scratch correcting unit 21, an OB processing unit 22, a Low Pass Filter (LPF) 23, an IR subtracting unit 24, a white balance adjusting unit 25, a color signal processing unit 26, a color gain unit 27, a luminance signal processing unit 28, and a combining unit 29.

In the case where the solid-state imaging element 10 has a pixel defect, the scratch correcting unit 21 replaces the signal from the defective pixel with a signal from an adjacent pixel.

The OB processing unit 22 adjusts the level of a black signal based on a signal from a light-shielded unit-pixel which is positioned at the edge of the image-capturing region 11 in the solid-state imaging element 10.

The LPF 23 removes a high-frequency noise component included in the image signals.

The IR subtracting unit 24 is an infrared difference unit which generates color signals by subtracting an IR signal that is an electrical signal from the unit-pixel 12, from each of an (R+IR) signal that is an electrical signal from the unit-pixel 14, a (B+IR) signal that is an electrical signal from the unit-pixel 15, and a (G+IR) signal that is an electrical signal from the unit-pixel 16. The color signals generated in the IR subtracting unit 24 are subjected to white balance processing in the white balance adjusting unit 25, color phase and saturation processing in the color signal processing unit 26, and color gain adjustment in the color gain unit 27, and then are combined with a luminance signal generated in the luminance signal processing unit 28 in the combining unit 29. The composite of the color signals and the luminance signal is a color image signal.

It should be noted that the luminance signal generated in the luminance signal processing unit 28 is:

Y={(R+IR)+(G+IR)+(B+IR)+IR}/4 (Equation 1)

or

Y={(R+IR)+(G+IR)+(B+IR)+IR}/4−αIR (Equation 2)

where α is a coefficient from 0 to 1.

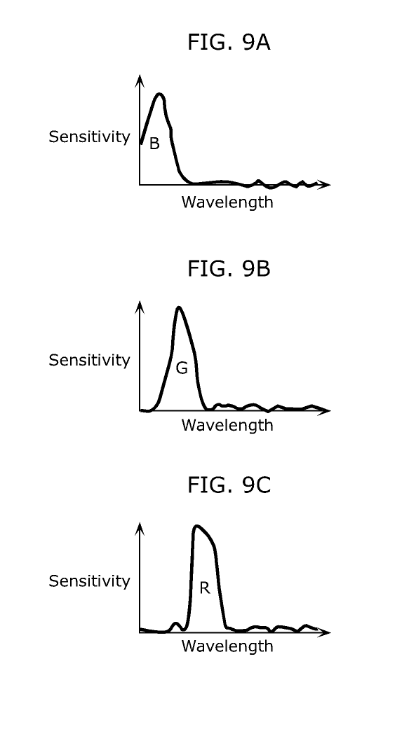

FIGS. 9A to 9C are graphs showing the spectral sensitivity characteristics obtained by subtracting the spectral sensitivity characteristics in FIG. 7D from each of the spectral sensitivity characteristics in FIGS. 7A to 7C, respectively. As shown in the graphs, it can be seen that subtracting the IR signal from each of the (R+IR) signal, the (G+IR) signal, and the (B+IR) signal generates color signals.

Accordingly, the color signals are generated by subtracting the signal from the unit-pixel 12, from the signal from each of the unit-pixels 14, 15, and 16, and the luminance signal is generated from the signals from the unit-pixels 12, 14, 15, and 16. Accordingly, a color image signal is obtained by combining the color signals and the luminance signal, and a monochrome image signal is obtained by directly using the luminance signal.

Moreover, the signal processing unit 20 is capable of selecting either the monochrome image signal generated only from the luminance signal or a pseudo color image signal, as an infrared image signal when the infrared LED is ON. When the infrared LED is ON, the amount of visible light is smaller than the amount of infrared light. Therefore, a sufficient color signal cannot be obtained, resulting in a pseudo color image signal.

The above-described arrangement of the unit-pixels allows the signal processing unit 20 to generate a color visible-light image in which the signals from the unit-pixels 14, 15, and 16 having prioritized sensitivity to visible light are dominant, for example, when the subject is irradiated with only light from a halogen lamp. On the other hand, for example, in the state where irradiation with infrared LED light is added to the irradiation with light from a halogen lamp, it is possible to generate an infrared image in which the signal from the unit-pixel 12 having sensitivity to infrared light is dominant.

Next, the following describes the result of image-capturing in dim light by the image-capturing device 100 according to this embodiment.

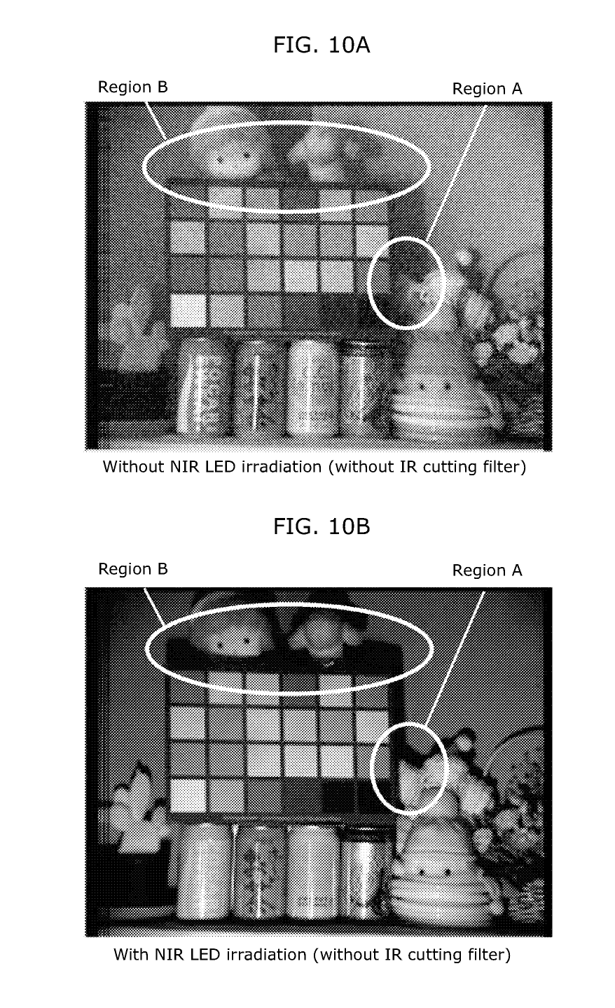

FIG. 10A is an image captured by the image-capturing device according to Embodiment 1 of the present invention in the state of being irradiated with light from a halogen lamp, and FIG. 10B is an image captured by the image-capturing device according to Embodiment 1 of the present invention in the state of being irradiated with infrared light in addition to the light from the halogen lamp.

The image shown in FIG. 10A is an image captured in the state of being irradiated with light from a halogen lamp in such a manner that the color temperature is 2850 K and illuminance on the subject is 1 lux. Moreover, the image shown in FIG. 10B is an image captured in the state of being irradiated with infrared LED light the irradiation intensity of which on the subject is 50 μW, in addition to the halogen lamp the color temperature of which is 2850 K and illuminance on the subject is 1 lux.

In the region A shown in FIG. 10A, the subject is darkened by shadow and is difficult to be seen. However, in the region A shown in FIG. 10B, the subject is clearly seen. On the contrary, in the region B shown in FIG. 10B, the subject is darkened by shadow and is difficult to be seen, however, in the region B shown in FIG. 10A, the subject is clearly seen.

Accordingly, the image-capturing device 100 according to Embodiment 1 of the present invention image-captures both a color visible-light image and an infrared image by electrically switching between the images in high speed, so that the subject hidden by shadow can be seen. Thus, the image-capturing device 100 has a significant advantage in monitoring application.

As described above with reference to the drawings, the image-capturing device 100 according to Embodiment 1 of the present invention includes the solid-state imaging element 10, the infrared LED 70 which emits infrared light, the light-emission controlling unit 60 which causes the infrared LED 70 to emit infrared pulsed light on a per frame time basis, and the signal processing unit 20 which separately extracts a color visible-light image signal and an infrared image signal from the solid-state imaging element 10 according to a modulation. Moreover, the solid-state imaging element 10 includes the image-capturing region 11 in which the unit-arrays are two-dimensionally arranged, and each unit-array includes the pixel having the filter to allow green visible light and infrared light to pass, the pixel having the filter to allow red visible light and infrared light to pass, the pixel having the filter to allow blue visible light and infrared light to pass, and the pixel having the filter to allow infrared light to pass. With this, it is possible to almost simultaneously obtain a color visible-light image and a monochrome image having clear contrast made by irradiation of infrared light on a per frame basis without a mechanical system for switching between the images. Furthermore, by almost simultaneously viewing both the above color image and the above monochrome image, it is possible to perceive, with clear contrast, even a part of the color image hidden by shadow, and to identify in the color image the color of the subject, for example the color of the clothes, which cannot be perceived only from the above monochrome image.

Furthermore, the signal processing unit 20 in the image-capturing device 100 includes the infrared difference unit which subtracts a signal from the pixel having the filter to allow infrared light to pass from a signal from each of the pixel having the filter to allow green visible light and infrared light to pass, the pixel having the filter to allow red visible light and infrared light to pass, and the pixel having the filter to allow blue visible light and infrared light to pass. Accordingly, by including the pixel having sensitivity in visible light and the pixel having sensitivity in infrared light, an image in daytime (a visible-light image) and an infrared image can be electronically switched, the visible-light image and the infrared image can be captured almost simultaneously, and furthermore, color reproduction of the visible-light image can be improved.

Furthermore, in the unit-array in the solid-state imaging element 10, for example, the pixel having the filter to allow green visible light and infrared light to pass and the pixel having the filter to allow infrared light to pass are adjacent to each other in the row or the column direction, and the pixel having the filter to allow green visible light and infrared light to pass and the pixel having the filter to allow red visible light and infrared light to pass are diagonally positioned. Accordingly, an R pixel and a G pixel having high coefficients of a luminance signal Y (expressed by Y=0.3R+0.6G+0.1B) that is related to the brightness and contrast of an image are diagonally positioned, so that the center of the luminance signal Y comes to near the center of the unit-array. As a result, an image of good quality can be provided without deteriorating a sense of resolution.

### Embodiment 2

In an image-capturing device according to Embodiment 2 of the present invention, timing to drive the infrared LED 70 to emit pulsed light is different from that in Embodiment 1. The following mainly describes the timing to drive the infrared LED 70 to emit pulsed light, and the description of the same structure as that in Embodiment 1 is omitted.

The controlling unit 40 determines the timing to drive the infrared LED 70 to emit pulsed light based on the timing of a horizontal blanking period and the timing of an image-capturing period of one frame of the solid-state imaging element 10. Moreover, the infrared LED 70 emits the pulsed light in response to the driving pulse signal generated by the light-emission controlling unit 60.

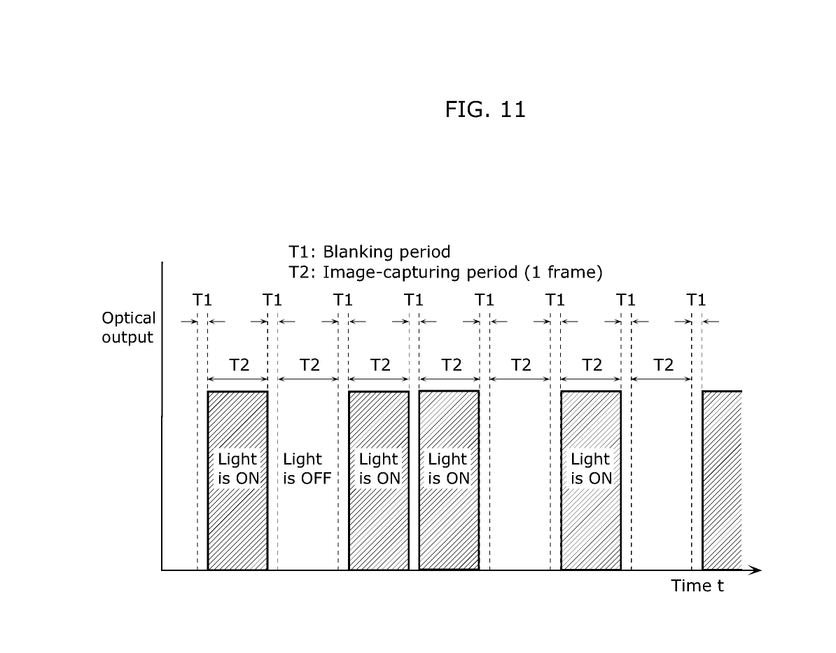

FIG. 11 is a timing chart showing emission timing of the infrared LED 70 according to Embodiment 2 of the present invention. The infrared LED 70 is repeatedly turned ON or OFF in a pseudorandom manner. When turned ON, the infrared LED 70 starts emitting pulsed light during a horizontal blanking period, and when turned OFF, the infrared LED 70 stops emitting the pulsed light during a horizontal blanking period. The infrared LED 70 is repeatedly turned ON or OFF on a per frame basis in a pseudorandom manner.

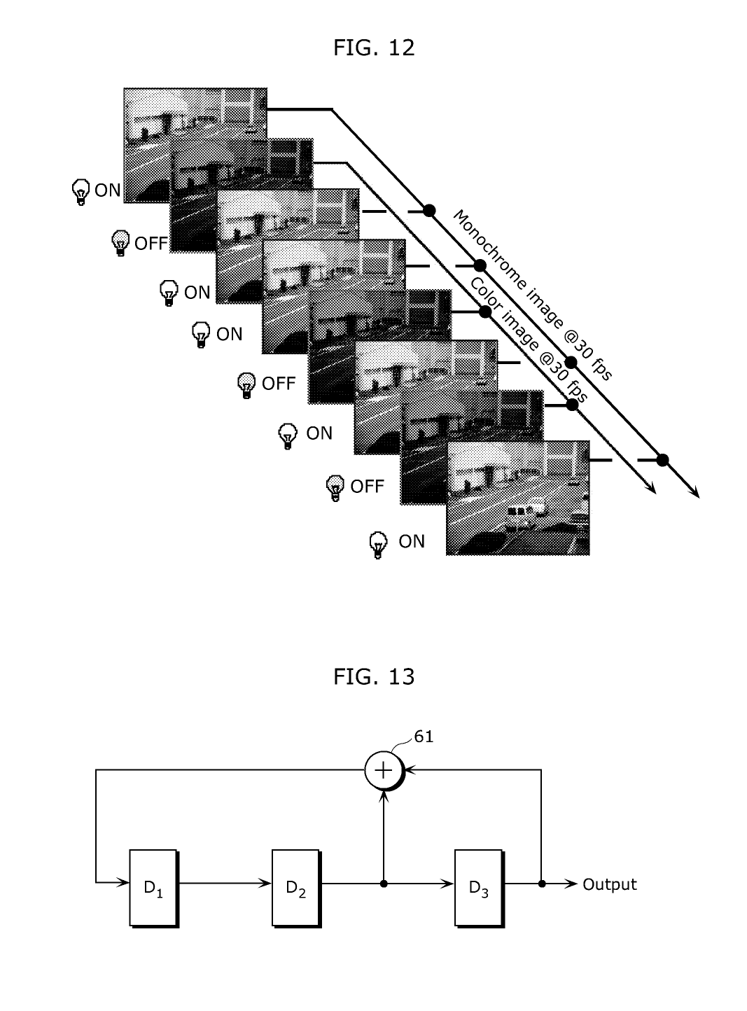

FIG. 12 is a diagram showing temporal transition of images captured in dim light by the image-capturing device according to Embodiment 2 of the present invention. The controlling unit 40 turns the infrared LED 70 ON or OFF on a per frame basis in a pseudorandom manner, and causes the solid-state imaging element to drive at 1/60 second per frame. In this case, the image-capturing device can separately image-capture, in dim light, a color image and a monochrome image that is given clear contrast by infrared light approximately 30 fps for each in synchronization with OFF or ON of the infrared LED 70.

Furthermore, the pulsed light emitted from the infrared LED 70 may be modulated in a pseudorandom manner using the spread spectrum system, that is, the modulated infrared light can be emitted from the infrared LED 70 on a per frame time basis as pseudorandom pulses.

A spread code sequence used in the spread spectrum system is preferably made up of codes the speed of which is sufficiently over the bit rate of data, and has uniform spectrums in the bandwidth. Moreover, the spread code sequence preferably has periodicity because of ease of demodulation. Such demands are satisfied with a pseudorandom sequence PN sequence. The PN sequence is artificially generated based on a certain rule by a circuit using a shift register and feedback. The best known PN sequence is a Maximal-length Sequence (M-sequence), which has good correlation characteristics. The M-sequence is a sequence the period of which is the longest among code sequences generated by a shift register having a certain length through feedback. Given that the number of stages of shift registers is n, the bit length of an M-sequence is L=2n−1.

In this case, the image-capturing device according to Embodiment 2 can be applied to a headlight module, and the light-emission controlling unit 60 in FIG. 1 includes an M-sequence signal generator.

FIG. 13 is a diagram showing an example of a circuit configuration of the M-sequence signal generator in the light-emission controlling unit 60 according to Embodiment 2 of the present invention. The M-sequence signal generator shown in the diagram includes three shift registers D₁ to D₃ and an exclusive OR circuit (EXOR) 61. Each of the shift registers D₁ to D₃ is a one-bit delay element. Setting the initial values of the shift registers D₁ and D₂ to “0” and setting the initial values of the shift register D₃ to “1” can generate a signal sequence “1001011” of L=2³−1=7 bits.

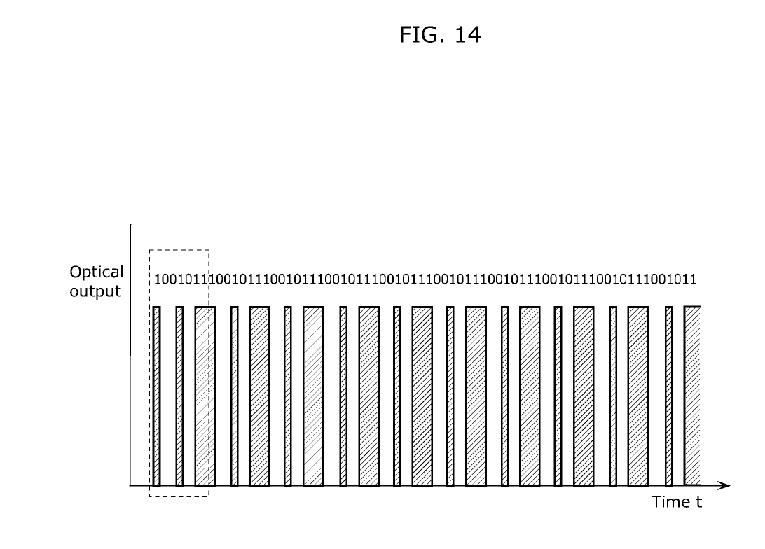

FIG. 14 is a timing chart showing emission timing of the infrared LED generated by the M-sequence signal generator. The light-emission controlling unit 60 causes the infrared LED 70 to emit at the timing of a pulse signal temporally modulated in a pseudorandom manner by the spread spectrum system. In other words, the light-emission controlling unit 60 causes the infrared LED 70 to emit infrared light temporally modulated in a pseudorandom manner by the spread spectrum system.

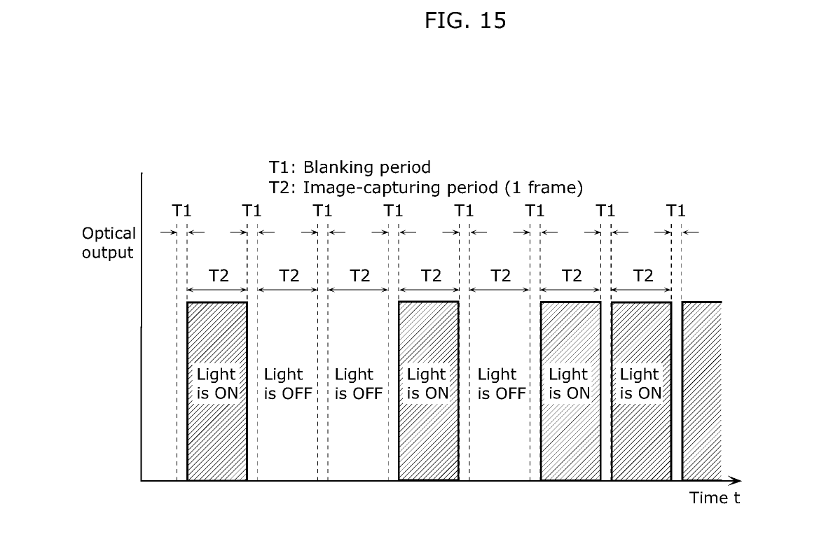

FIG. 15 is a timing chart showing emission timing of the infrared LED according to Embodiment 2 of the present invention. The infrared LED 70 emits infrared light to a subject according to the emission timing generated by the M-sequence signal generator, and the solid-state imaging element 10 image-captures the infrared light reflected from the subject. The image-capturing device can extract only the infrared light emitted by itself by receiving the signal captured by the solid-state imaging element 10 at the timing of the pulse signal temporally modulated in a pseudorandom manner by the spread spectrum system. Accordingly, the image signal is extracted according to the pseudorandom modulation, so that possible incident light from other light sources on the solid-state imaging element 10 can be separated. Furthermore, use of the light modulated by the spread spectrum system enables a relative position of a moving object to be measured by the difference in arrival time of the light.

Furthermore, although it has been described that the solid-state imaging element 10 receives the signal at the timing of the pulse signal, the signal captured by the solid-state imaging element 10 may be despreaded. In this case, since the signal is despreaded, it is possible to have resistance to disturbance wave and interference wave, and to increase the S/N ratio.

It should to be noted that a Gold sequence may be used as the PN sequence. Furthermore, a Reed-Solomon code may be used for code correction.

As described above with reference to the drawings, the image-capturing device according to this embodiment of the present invention is characterized in that the light-emission controlling unit 60 causes the infrared LED 70 to emit the modulated infrared light on a per frame time basis as pseudorandom pulses. Accordingly, the emitted infrared light is temporally modulated in a pseudorandom manner and the signals are extracted according to the modulation, so that the influence of ambient light can be reduced.

Moreover, the light-emission controlling unit 60 has a function to cause the infrared LED 70 to emit the infrared light temporally modulated in a pseudorandom manner by the spread spectrum system. With this, the subject is irradiated with the spread-spectrum infrared light, and the spread-spectrum infrared light reflected from the subject is received. The above-described spread spectrum allows the infrared light to be spread in a broadband, so that ambient light in a narrowband can be easily separated from the infrared light. Furthermore, use of the light modulated by the spread spectrum system enables the relative position of the moving object to be measured by the difference in arrival time of the light.

It should be noted that the image-capturing device according to the present invention is not limited to Embodiments 1 and 2. Those skilled in the art will readily appreciate that the present invention includes (a) alternative embodiments obtainable by arbitrarily combining any of the elements in Embodiments 1 and 2, (b) various kinds of modifications to Embodiments 1 and 2 conceivable without materially departing from the scope of the present invention, and (c) various kinds of apparatuses including therein the image-capturing device according to the present invention.

Furthermore, the image-capturing device according to the present invention may include a detecting unit for detecting whether or not a signal from the pixel having the filter that allows infrared light to pass has intensity greater than or equal to a predetermined intensity, and a light reducing unit for reducing infrared light when the detection unit determines the signal has intensity equal to or larger than the predetermined intensity. With this, in the case where the captured signals in the solid-state imaging element 10 are saturated, it is possible to reduce light incident on the solid-state imaging element 10.

Furthermore, as illustrated in FIG. 1, the image-capturing device may include the signal accumulating unit 50 which separately accumulates a color visible-light image signal and an infrared image signal. With this, it is possible to usually monitor a color image, and to check an infrared image only in case of emergency.

Furthermore, the solid-state imaging element 10 includes, for example, the signal outputting unit which outputs the color visible-light image signal or the infrared image signal at 1/60 second or less. With this, it is possible to view the color visible-light image signal and the infrared image signal at 1/30 second or less for each, and thus to view the captured image without flickering or the like.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The image-capturing device according to the present invention is applicable to a camera which is capable of simultaneously outputting a color visible-light image and a monochrome infrared image, and particularly useful for an in-vehicle camera, a monitoring camera, and others.

1. An image-capturing device comprising:
a solid-state imaging element including an image-capturing region in which unit-arrays are two-dimensionally arranged, each of the unit-arrays including a first unit-pixel having a filter that allows green visible light and infrared light to pass, a second unit-pixel having a filter that allows red visible light and infrared light to pass, a third unit-pixel having a filter that allows blue visible light and infrared light to pass, and a fourth unit-pixel having a filter that allows infrared light to pass;
a light-emitting element which emits infrared light;
a light-emission controlling unit configured to cause the light-emitting element to emit pulses of the infrared light by turning the light-emitting element ON or OFF on a per frame time basis; and
a signal extracting unit configured to extract, from the solid-state imaging element, a color visible-light image signal in synchronization with a non light-emitting period of the light-emitting element and an infrared image signal in synchronization with a light-emitting period of the light-emitting element, the light-emitting element being turned OFF or ON by the light-emission controlling unit.

2. The image-capturing device according to claim 1,
wherein the signal extracting unit:
includes an infrared difference unit configured to subtract a signal from the fourth unit-pixel from a signal from each of the first unit-pixel, the second unit-pixel, the third unit-pixel to generate color signals; and
is configured to extract the color visible-light image signal or the infrared image signal from the color signals generated by the infrared difference unit and a luminance signal generated from any one of the first to the fourth unit-pixels.

3. The image-capturing device according to claim 1,
wherein, in each of the unit-arrays:
the first unit-pixel and the fourth unit pixel are adjacent to each other in a row direction or a column direction; and
the first unit-pixel and the second unit-pixel are diagonally positioned.

4. The image-capturing device according to claim 1,
wherein the light-emission controlling unit is configured to cause the light-emitting element to emit, in pseudorandom pulses, the infrared light that is turned ON or OFF on a per frame time basis.

5. The image-capturing device according to claim 4,
wherein the pseudorandom pulses are pulses of emitted light temporally modulated by the light-emission controlling unit in a pseudorandom manner using a spread spectrum system.

6. The image-capturing device according to claim 5,
wherein the signal extracting unit is configured to separately extract the color visible-light image signal and the infrared image signal by despreading image signals captured by the solid-state imaging element.

7. The image-capturing device according to claim 1, further comprising:
a detecting unit configured to detect whether or not intensity of the signal from the fourth unit-pixel is greater than or equal to predetermined intensity; and
a light reducing unit configured to reduce the infrared light when the detection unit determines the intensity of the signal is greater than or equal to the predetermined intensity.

8. The image-capturing device according to claim 1, further comprising
an accumulating unit configured to accumulate at least one of the color visible-light image signal and the infrared image signal.

9. The image-capturing device according to claim 1,
wherein the solid-state imaging element includes
a signal outputting unit configured to output the color visible-light image signal or the infrared image signal at 1/60 second or less.
